(19) United States
(12) Patent Application Publication
(10) Pub. No.: US 2017/0170440 A1
(43) Pub. Date: Jun. 15, 2017

(54) METHOD FOR MAKING COMPOSITE SEPARATOR

(71) Applicants: JIANGSU HUADONG INSTITUTE OF LI-ION BATTERY CO., LTD., Suzhou (CN); TSINGHUA UNIVERSITY, Beijing (CN)

(72) Inventors: Jiang Cao, Beijing (CN); Xiang-Ming He, Beijing (CN); Yu-Ming Shang, Beijing (CN); Li Wang, Beijing (CN); Jian-Jun Li, Beijing (CN); Hong-Sheng Zhang, Suzhou (CN); Jian Gao, Beijing (CN); Yao-Wu Wang, Beijing (CN); Jing Luo, Suzhou (CN); Zhen Liu, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/442,531

(22) Filed: Feb. 24, 2017

Related U.S. Application Data
(63) Continuation of application No. PCT/CN2015/082725, filed on Jun. 30, 2015.

(30) Foreign Application Priority Data
Aug. 28, 2014 (CN) 201410430500.9

(51) Int. Cl. H01M 2/14; H01M 2/16

(52) U.S. Cl. CPC H01M 2/145; H01M 2/1686; H01M 2/166

(57) ABSTRACT

A method for making a composite separator is disclosed. In the method, a liquid dispersion of single ion nanoconductors is prepared. The liquid dispersion of the single ion nanoconductors is uniformly mixed with a polymer to form a film casting solution. The film casting solution is applied to a surface of a porous film.

### CROSS-REFERENCE TO RELATED APPLICATIONS

This application claims all benefits accruing under 35 U.S.C. §119 from China Patent Application No. 201410430500.9, filed on Aug. 28, 2014 in the State Intellectual Property Office of China, the contents of which are hereby incorporated by reference. This application is a continuation of international patent application PCT/CN2015/082725 filed Jun. 30, 2015, the content of which is hereby incorporated by reference.

### FIELD

The present disclosure relates to methods for making composite separators.

### BACKGROUND

As the use of the lithium ion batteries increases greatly in new energy fields such as mobile phones, electric vehicles, and energy storage systems, safety becomes an issue. Cause based analyses can be performed to make improvements to the safety of the lithium ion battery. One such improvement is to optimize the design and management of the lithium ion batteries, which include monitoring the charge and discharge processes of the lithium ion batteries in real-time and handling safety maintenance issues of the lithium ion batteries. Another is to improve or develop new electrode materials, which increase an intrinsic safety performance of the battery. New and safer type of electrolytes and separators may also be used to improve the safety of the lithium ion batteries.

A separator is a critical component in a lithium ion battery. The separator prevents a short circuit between the anode and cathode electrodes and is capable of passing electrolyte ions. A conventional lithium ion battery separator is a microporous film formed by polyolefin such as polypropylene (PP) and polyethylene (PE) uses physical (such as extending) or chemical (such as extraction) methods. Commercial separator products are provided by Asahi Kasei®, Tonen, and Ube®, and Celgard®. As a matrix of the separator, polyolefin has a high strength and a good stability in acids, alkalis, and solvents. However, the melting point of polyolefin is relatively low (the melting point of PE is about 130° C., and the melting point of PP is about 160° C.), which causes a contraction and meltdown of the separator at high temperature, which could result in a burning or exploding battery.

A conventional method for improving the heat resistance of a separator is to add oxide nanoparticles such as titanium dioxide nanoparticles, silicon dioxide nanoparticles, or alumina nanoparticles to the separator. However, the nanoparticles or nanomaterials have a large specific surface area, which tend to aggregate together and become difficult to disperse. Therefore, the difficulty is to uniformly composite the nanoparticles with the separator, which can often lead to an unsatisfactory performance of the final product.

### BRIEF DESCRIPTION OF THE DRAWINGS

FIG. 1 is a flow chart of one embodiment of a method for making a composite separator.

FIG. 2 is a schematic view of a chemical reaction process of one embodiment of a method for preparing a single ion nanoconductor using tetrabutyl titanate.

FIG. 3 is a graph showing an infrared spectrum of one embodiment of nano TiO₂-P(AALi-MMA).

FIG. 4 shows high-resolution transmission electron microscopy (HRTEM) characterization images in different magnifications of one embodiment of a liquid dispersion.

FIG. 5A is a graph showing a scanning electron microscope (SEM) image of un-coating PVDF-HFP electrospinning film in Example 1.

FIG. 5B is a graph showing a SEM image of a surface of a coating layer in the composite separator in Example 1.

FIG. 5C is a graph showing a SEM image of one surface of the composite separator that is not coated with a film casting solution in Example 1.

FIG. 5D is a graph showing a SEM image of a cross section of the composite separator in Example 1.

FIG. 6 is a graph showing tensile strength curves of the composite separators in Examples 1 to 3 and a PVDF-HFP electrospinning film.

FIG. 7A is a graph showing changes of ionic conductivities of the composite separators in Examples 1 to 3 and the PVDF-HFP electrospinning film with respect to temperature.

FIG. 7B is a graph showing impedance spectrums of the composite separator in Example 1 at different temperatures.

FIG. 8 is a graph showing discharge curves at different current rates of a lithium ion battery in Comparative Example 1.

FIG. 9 is a graph showing discharge curves at different current rates of the lithium ion battery in Example 1.

FIG. 10 is a graph showing cycling test performances at different current rates of the lithium ion batteries in Example 1 and Comparative Example 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

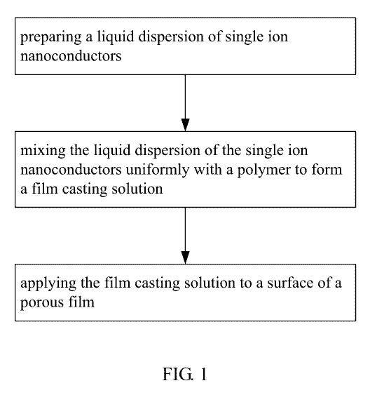

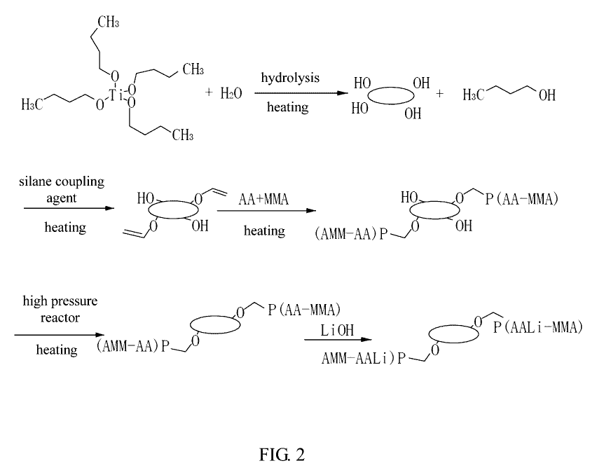

Referring to FIG. 1, one embodiment of a method for making a composite separator comprises:

(1), preparing a liquid dispersion of single ion nanoconductors;

(2), mixing the liquid dispersion of the single ion nanoconductors uniformly with a polymer to form a film casting solution; and

(3), applying the film casting solution to a surface of a porous film.

Step (1) can further comprise:

S1, forming a solution of nano sol through a hydrolysis reaction, the nano sol is selected from at least one of a titanium sol, an aluminum sol, a silicon sol, and a zirconium sol, in which S1 comprises:

S11, dissolving at least one of a titanium compound, an aluminum compound, a silicon compound, and a zirconium compound, capable of having a hydrolysis reaction in an organic solvent to form a first solution;

S12, forming a second solution by mixing water and another organic solvent; and

S13, mixing the first solution with the second solution and heating the mixture to form the solution of nano sol, wherein the step S12 or S13 further comprises adjusting a pH value of the second solution or the mixture of the first and second solutions to 3 to 4 or 9 to 10 by adding acid or alkali;

S2, adding a silane coupling agent containing a C═C group in the solution of nano sol, and heating in a protective gas to have a reaction thereby obtaining a solution of C═C group grafted nano sol;

S3, adding a methyl methacrylate (MMA) monomer, an acrylic acid (AA) monomer, and an initiator to the solution of C═C group grafted nano sol, and heating to have a reaction thereby forming a nano sol-P(AA-MMA) composite;

S4, heating the nano sol-P(AA-MMA) composite at an elevated pressure in a liquid phase medium of a high-pressure reactor at a temperature of 145° C. to 200° C. and a pressure of 1 MPa to 2 MPa to obtain a complete dehydroxy crystalline oxide nanoparticle-P(AA-MMA) composite, the oxide nanoparticles being at least one oxide of titanium, aluminum, silicon, and zirconium; and

S5, mixing and heating the oxide nanoparticle-P(AA-MMA) composite and lithium hydroxide in an organic solvent to obtain a transparent and clear liquid dispersion of the single ion nanoconductors.

In step S1, the nano sol is formed by hydrolyzing at least one of a titanium compound, an aluminum compound, a silicon compound, and a zirconium compound with water. The nano sol comprises a large amount of MOH groups, wherein M is titanium, aluminum, silicon, or zirconium, and the hydroxyl groups are grafted to titanium, aluminum, silicon, or zirconium.

The titanium compound, aluminum compound, silicon compound, and zirconium compound that are capable of having the hydrolysis reaction can be at least one of an organic ester compound, an organic alcohol compound, an oxysalt, and a halide, examples of which can be tetraethyl orthosilicate, tetramethyl orthosilicate, triethoxysilane, trimethoxysilane, trimethoxy(methyl)silane, methyltriethoxysilane, aluminium isopropoxide, aluminium tri-sec-butoxide, titanium sulfate (Ti(SO₄)₂), titanium tetrachloride (TiCl₄), tetrabutyl titanate, titanium(IV) ethoxide, titanium tetraisopropanolate, titanium(IV) tert-butoxide, diethyl titanate, zirconium(IV) butoxide, zirconium tetrachloride (ZrCl₄), zirconium(IV) tert-butoxide, and zirconium n-propoxide.

In the adjusting the pH value in step S12 or S13, the acid added to the second solution can be at least one of a nitric acid, a sulfuric acid, a hydrochloric acid, and an acetic acid, and the alkali added to the second solution can be at least one of sodium hydroxide, potassium hydroxide, and ammonia water. A molar ratio of the water in the second solution to titanium, aluminum, silicon, and zirconium in the first solution (H₂O:M) can be 3:1 to 4:1. The organic solvent that is used in S1 can be a common choice such as ethanol, methanol, acetone, chloroform, and isopropyl alcohol. A volume ratio of the organic solvent to at least one of the titanium compound, aluminum compound, silicon compound, and zirconium compound can be 1:1 to 10:1. In step S13, the heating temperature can be 55° C. to 75° C.

In step S2, the C═C group contained silane coupling agent can be at least one of diethylmethylvinylsilane, vinyltris(tert-butylperoxy)silane, ethoxydimethylvinylsilane, vinyltri-t-butoxysilane, vinyltriisopropenoxysilane, diethoxy(methyl)vinylsilane, triethoxyvinylsilane, vinyltrimethoxysilane, dimethoxymethylvinylsilane, diethoxymethylvinylsilane, vinyltriacetoxysilane, tri(isopropoxy)vinylsilane, trimethoxy(7-octen-1-yl)silane, and vinylmethyldimethoxysilane.

The solution of nano sol can comprise water. The silane coupling agent can have a hydrolysis reaction by being added in the solution of nano sol to form SiOH group. The silane coupling agent also can have SiOR group, wherein R is hydrocarbon group, such as alkyl group. In step S2, the SiOH group (or SiOR group) reacts with the MOH group to form an Si—O-M group, thereby grafting C═C groups of the silane coupling agent onto the surface of the nano sol. In step S2, the heating temperature can be about 60° C. to about 90° C., and the protective gas can be nitrogen gas or an inert gas. A molar ratio of the nano sol to the silane coupling agent can be about 1:100 to about 1:20.

In step S3, the MMA, the AA, and the C═C groups grafted nano sol are copolymerized under the action of the initiator and the heating to form the nano sol-P(AA-MMA) composite. Specifically, the initiator causes a polymerization between the MMA and the AA to form a copolymer (P(AA-MMA), P stands for poly) while allowing the C═C double bond of the nano sol to open and copolymerize with the C═C group of the MMA and/or the AA thereby grafting/joining the nano sol to the P(AA-MMA). The process of the polymerization can be accompanied by heating and stirring, so that the nano sol can be uniformly polymerized with the MMA and the AA, and the nano sol can be evenly distributed in the obtained polymer. The initiator can be benzoyl peroxide, azobisisobutyronitrile (AIBN), or 2,2′-azobis(2,4-dimethylvaleronitrile) (ABVN).

A molar ratio of the MMA to the AA can be about 20:1 to about 10:1. A mass ratio of the nano sol to the sum of the MMA and the AA is about 10:1 to about 5:1 (i.e., nano sol:MMA+AA=about 10:1 to about 5:1).

The polymerization in step S3 can be carried out in the heating condition, the temperature of which can be maintained at about 60° C. to about 90° C. as in the step S2.

The nano sol-P(AA-MMA) composite obtained by the steps S1 to S3 of the present invention is an inorganic-organic grafting hybrid polymer obtained by copolymerizing the AA, the MMA, and the C═C group grafted nano sol. In steps S1 to S3, the nano sol is obtained by hydrolyzing at least one of the titanium compound, aluminum compound, silicon compound, and zirconium compound. The nano sol contains a network formed by M-O bonds, and the macroscopic chemical composition of the network can be regarded as an oxide of titanium, aluminum, silicon and/or zirconium. The oxide has an amorphous structure and is grafted with a large amount of hydroxyl groups.

In step S4, the nano sol-P(AA-MMA) composite is placed in the liquid phase medium such as water or an organic solvent and sealed in the high-pressure reactor to undergo a reaction process. This reaction process crystallizes the amorphous oxide and completely removes the hydroxyl group grafted to the oxide (e.g., dehydroxylation). By controlling the temperature and pressure of the reaction process, the oxide particles can be prevented from aggregation during the dehydroxylation, thereby forming crystalline nanoparticles of oxide which are highly dispersed. The nanoparticles of oxide can be at least one of titanium dioxide (TiO₂) nanoparticles, aluminum oxide (Al₂O₃) nanoparticles, silicon dioxide (SiO₂) nanoparticles, and zirconium dioxide (ZrO₂) nanoparticles. The nanoparticles are still grafted to the organic polymer P(AA-MMA). The polymer is coated on the surface of the nanoparticles.

In step S5, the poly acrylic acid (PAA) in the oxide nanoparticle-P(AA-MMA) composite contains a COOH group, which reacts with LiOH to form a COOLi group, thereby forming oxide nanoparticle-P(AALi-MMA), namely, the single ion nanoconductor. By carrying out the step S5 in a stepwise manner, when the oxide nanoparticle-P(AA-MMA) composite is dispersed in the organic solvent, a pale yellow opaque emulsion is formed indicating that the oxide nanoparticle-P(AA-MMA) composite has an aggregation in the organic solvent. Then LiOH is added in, and the emulsion is quickly changed into a uniform and stable transparent clear solution by simply stirring and heating, which indicates that the energy produced by the chemical reaction helps the rapid dispersion of oxide nanoparticles. Compared with the conventional dispersing method such as ultrasonic vibration, the present method reduces the energy consumption of dispersing the oxide nanoparticles and has a high dispersing efficiency. The transparent and clear liquid dispersion comprises the organic solvent and the single ion nanoconductors uniformly dispersed in the organic solvent. The organic solvent of step S5 can be a polar solvent, such as at least one of acetamide, N-methyl pyrrolidone (NMP), and acetone. The liquid dispersion comprises the organic solvent and single ion nanoconductors, e.g., oxide nanoparticle-P(AALi-MMA), dispersed in the organic solvent. The oxide nanoparticle-P(AALi-MMA) does not aggregate with each other and is in a monodisperse state. A size of the oxide nanoparticle-P(AALi-MMA) is less than 10 nanometers, e.g., about 4 nanometers to about 8 nanometers. The heating temperature in step S5 can be about 60° C. to about 90° C.

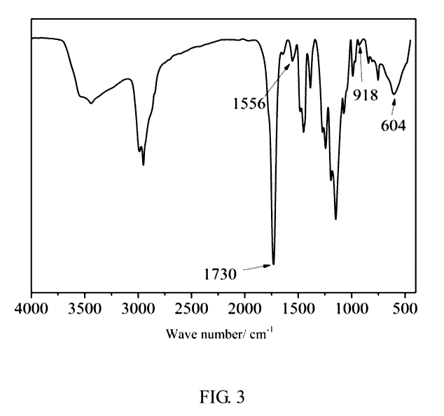

Referring to FIG. 3, a Fourier transform infrared spectroscopy (FTIR) analysis is applied on the single ion nanoconductors, in which the oxide nanoparticles are TiO₂. The peak at 604 cm⁻¹ corresponds to the Ti—O—Ti group. The peaks at 1730 cm⁻¹ and 1556 cm⁻¹ respectively correspond to the C═0 group and COO⁻ group in the P(AALi-MMA). The peak at 918 cm⁻¹ corresponds to the Si—O—Ti group, which shows that the titanium sol and the P(AALi-MMA) are coupled through the silane coupling agent.

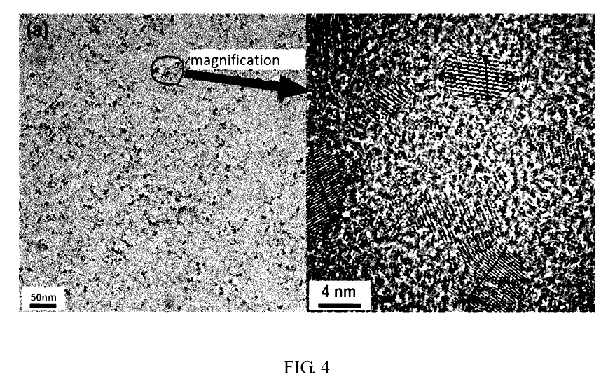

Referring to FIG. 4, the high resolution transmission electron microscopy (HRTEM) analysis of the transparent and clear liquid dispersion can further confirm that the oxide nanoparticle-P(AALi-MMA) prepared by the present method has a high dispersion effect. It can be seen from the HRTEM images at different resolutions that there is no aggregation between the single ion nanoconductors in the DMF solution, and the single ion nanoconductors are in a monodisperse state, which completely overcomes the dispersing difficulty of nanomaterial.

In step (2), the liquid dispersion of the single ion nanoconductors is uniformly mixed with the polymer, and an organic solvent can be further added to adjust the concentration in the film casting solution. The mixing can be carried out by means of mechanical stirring. Since the single ion nanoconductors themselves have the polymeric group, i.e., the P(AALi-MMA), they are easy to form a homogeneous mixture with the other polymer in the film casting solution. Without ultrasonic vibration, the oxide nanoparticles can be uniformly dispersed in the polymer to form the uniform and stable film casting solution.

The polymer can be selected from gel polymers commonly used in gel polymer electrolyte lithium ion batteries, such as poly(methyl methacrylate), poly(vinylidene fluoride-hexafluoropropylene) (PVDF-HFP), polyacrylonitrile, and polyethylene oxide (PEO). The organic solvent can be selected from one or more of N-methylpyrrolidone, N,N-dimethylformamide (DMF), N,N-dimethylacetamide (DMAc), tetrahydrofuran, and acetone. A mass ratio of the single ion nanoconductors to the polymer can be about 1:20 to about 1:1.

A total concentration of the single ion nanoconductor and the polymer in the film casting solution can be about 5% to about 80%, and can be about 10% to about 20% in some embodiments.

In step (3), the porous film can be selected from conventionally used separators in the lithium ion batteries, such as a polyolefin porous film, a nonwoven fabric porous film, or an electrospinning film. Examples of the polyolefin porous film include a polypropylene porous film, a polyethylene porous film, and a lamination of the polypropylene porous film and the polyethylene porous film. Examples of the nonwoven fabric include a polyimide nanofiber nonwoven fabric, a polyethylene terephthalate (PET) nanofiber nonwoven fabric, a cellulose nanofiber nonwoven fabric, an aramid nanofiber nonwoven fabric, a glass fiber nonwoven fabric, a nylon nanofiber nonwoven fabric, and a polyvinylidene fluoride (PVDF) nanofiber nonwoven fabric. Examples of the electrospinning film include a polyimide electrospinning film, a PET electrospinning film, and a PVDF electrospinning film. The porous film having the film casting solution attached thereto can be dried to form a coating layer on the surface of the porous film, for example, dried in a vacuum at about 40° C. to about 90° C. for about 24 hours to about 48 hours.

The step (3) can further comprise:
having the porous film immersed in the film casting solution and taken out, or coating the film casting solution on the surface of the porous film;
immersing the porous film having the film casting solution applied thereto in a pore-forming agent to form pores in the film casting solution; and
drying the porous film to form a coating layer on the surface of the porous film.

The pore-forming agent can be one or a mixture of water, ethanol, and methanol, which can extract the organic solvent out from the gel polymer to form micropores. It is to be understood that the immersing step of the porous film in the pore-forming agent is an optional step, and the micropores can be formed in the film casting solution by other conventional means. A thickness of the coating layer formed from drying the casting solution onto the porous film can be less than 50 microns, such as 2 microns to 10 microns. A total thickness of the composite separator can be less than 100 microns, and in some embodiments less than 50 microns.

The single ion nanoconductors are uniformly dispersed in the transparent and clear liquid dispersion so as to be able to easily form a uniform and stable mixture with the gel polymer. The formed film casting solution can be uniformly attached to the surface and the pores of the porous film, so as to realize the uniform distribution of the oxide nanoparticles in the composite separator, and to improve the mechanical properties and the heat resistance of the composite separator. In particular, the pores in most of the existing electrospinning films are too large, which may cause a short circuit in the lithium ion battery. By compositing the film casting solution and the electrospinning film can effectively solve this problem. In addition, since the single ion nanoconductors are capable of providing lithium ions, the composite separator can have better ionic conductivity, thereby improving the electrochemical performance of the lithium ion battery.

### EXAMPLE 1

10 mL of tetrabutyl titanate is mixed with 50 mL of ethanol to form a first solution. Deionized water is mixed with 50 mL of ethanol to form a second solution. The molar ratio of the deionized water to the tetrabutyl titanate is about 4:1. The second solution is slowly dropped into the first solution for mixing, the concentrated nitric acid is added to adjust the pH value to 3 to 4, and the mixture is stirred and heated at about 65° C. for about a half of an hour to obtain the titanium sol solution. The triethoxyvinylsilane is added to the titanium sol solution, and heated to about 80° C. for about 1 hour in the nitrogen gas to obtain a C═C group grafted titanium sol solution. The MMA monomer, the AA monomer, and benzoyl peroxide as the initiator are added to the C═C group grafted titanium sol solution with the reaction at about 80° C. for about 12 hours to obtain a solution of titanium dioxide nanosol-P(AA-MMA) composite. The solution of titanium dioxide nanosol-P(AA-MMA) composite is placed in an autoclave and heated at about 145° C. for about 24 hours to obtain a completely dehydroxy crystalline TiO₂-P(AA-MMA) composite, which is taken out and dried to obtain a light yellow solid powder. The dried nano TiO₂-P(AA-MMA) composite and LiOH are added to the organic solvent, and the mixture is stirred and heated to obtain the transparent and clear liquid dispersion.

The liquid dispersion is mixed with PVDF-HFP in DMF to form the film casting solution. The total concentration of the nano TiO₂-P(AA-MMA) composite and the PVDF-HFP in the film casting solution is about 20%, and a mass ratio of the nano TiO₂-P(AA-MMA) composite to the PVDF-HFP is about 1:1. The film casting solution is coated on one surface of the PVDF-HFP electrospinning film, immersed in deionized water for about 2 hours, then immersed in absolute ethanol for about 2 hours, and finally dried in a vacuum oven at about 80° C. for about 24 hours, resulting in a composite separator having a thickness of about 45 microns.

The mass percentage of the single ion nanoconductor in the coating layer of the composite separator is about 50%.

### EXAMPLE 2

Example 2 is the same as Example 1, except that the mass percentage of the single ion nanoconductor in the coating layer of the composite separator is about 10%.

### EXAMPLE 3

Example 3 is the same as Example 1, except that the mass percentage of the single ion nanoconductor in the coating layer of the composite separator is about 30%.

### EXAMPLE 4

Example 4 is the same as Example 1, except that tetrabutyl titanate is replaced with aluminium isopropoxide.

### EXAMPLE 5

Example 5 is the same as Example 1, except that tetrabutyl titanate is replaced by zirconium(IV) butoxide.

### EXAMPLE 6

Example 6 is the same as Example 1, except that tetrabutyl titanate is replaced by tetraethyl orthosilicate.

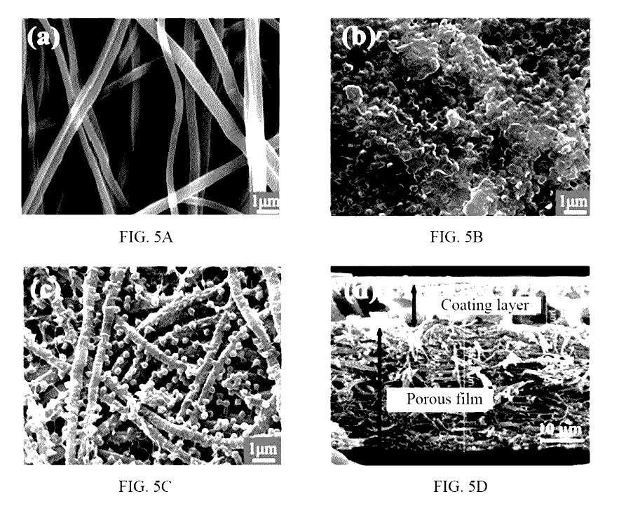

Referring to FIGS. 5A to 5D, which show SEM images of a composite separator obtained in Example 1 using a PVDF-HFP electrospinning film as a porous film having one surface coated with a film casting solution. The surface morphology and internal structure of the electrospinning film and the composite separator can be observed by the SEM. The internal pores of the electrospinning film are larger and the porosity is higher. After compositing with the coating layer, the internal pores are filled, and the coating layer has good compatibility with the PVDF-HFP electrospinning film. Even with the coating on a single surface, oxide nanoparticles can be uniformly distributed on the other surface of the composite separator due to the filling of the pores.

The composite separator of Example 1 and the polyolefin separator are subjected to a heat shrinkage test. The two separators are respectively sandwiched between two glass plates, heated in an oven at about 150° C. for about 2 hours, and the thermal contractions are measured by a scale. The polyolefin separator shrinks by 25% in the pull direction after the test, whereas the composite separator of Example 1 does not show significant shrinkage.

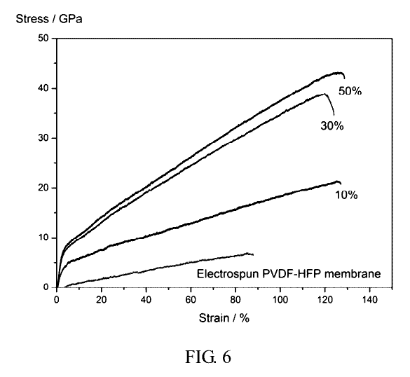

Referring to FIG. 6, the composite separators of Examples 1 to 3 and the uncoated PVDF-HFP electrospinning film are subjected to a tensile test, and it can be seen that as the content of the single ion nanoconductors in the coating layer increases from 10 wt % to 30 wt %, the mechanical strength of the composite separators is obviously enhanced, the deformation strength increases from 5.2 MPa to 7.3 MPa, and the fracture strength increases from 19 MPa to 35 MPa. When the content of single ion nanoconductors in the coating layer increases to 50 wt %, the deformation strength and the fracture strength increase to 8 MPa and 39 MPa, respectively. The mechanical strength of the composite separators can meet requirements of the application in the lithium ion battery.

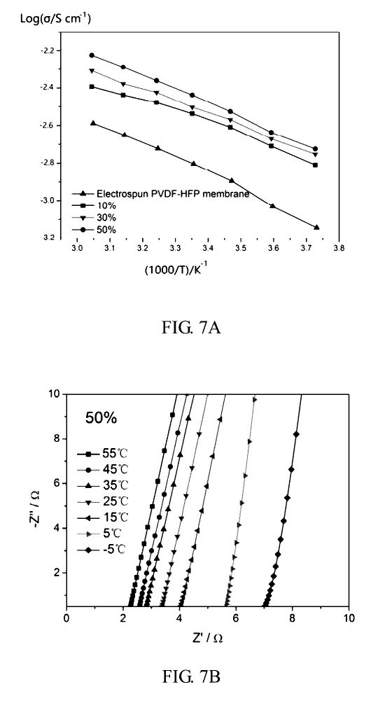

Referring to FIG. 7A and FIG. 7B, the ionic conductivity of the composite separators having different contents of single ion nanoconductors of Examples 1 to 3 and uncoated PVDF-HFP electrospinning films are measured at different temperatures. The ionic conductivity of the composite separators increases with the increase of the content of the single ion nanoconductors. When the content of the single ion nanoconductors reaches 50 wt %, the ionic conductivity of the composite separator reaches 3.63×10⁻³ S·cm⁻¹ at room temperature.

A lithium ion battery is assembled using the composite separator of Example 1, by having lithium cobalt oxide as a cathode active material. The lithium cobalt oxide is mixed with PVDF as a binder, and acetylene black and graphite as conducting agents, in NMP to form a cathode electrode slurry, and the slurry is coated on the surface of the aluminum foil to form a cathode electrode. A mass ratio of the cathode active material, PVDF, acetylene black, and graphite is that cathode active material:PVDF:acetylene black:graphite=8:1:1:1. LiPF6 is dissolved in a mixture of ethylene carbonate (EC), diethyl carbonate (DEC), and dimethyl carbonate (DMC) having a volume ratio as EC:DEC:EMC =1:1:1:1 to form an electrolyte solution, in which the concentration of LiPF6 is 1 mol/L. A counter electrode is lithium metal. The cathode electrode, the counter electrode, the electrolyte solution, and the composite separator of Example 1 are assembled into a 2032 button type lithium ion battery. The battery is cycled at constant current rates between 2.75V and 4.2V, wherein the constant current rates of the charging and discharging in the first 5 cycles are both 0.1 C. The following cycles all use 0.5 C as the charging current rate, and respectively use 1 C, 2 C, 5 C, and 8 C as the discharging current rate, each rate is for 5 cycles. The whole cycling test is performed at room temperature. In addition, another lithium ion battery is assembled and cycled under the same conditions above using a conventional polyolefin separator.

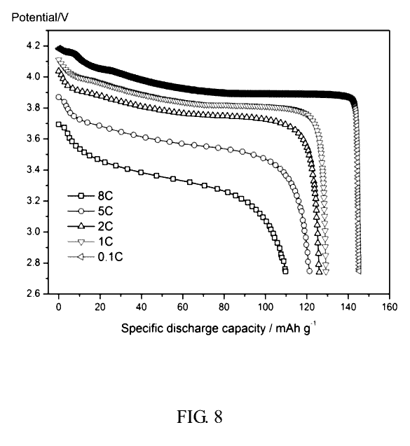

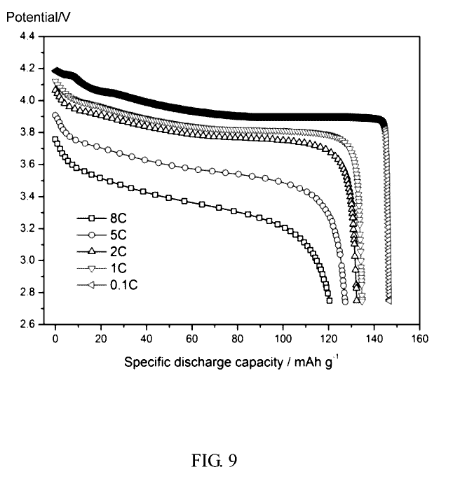

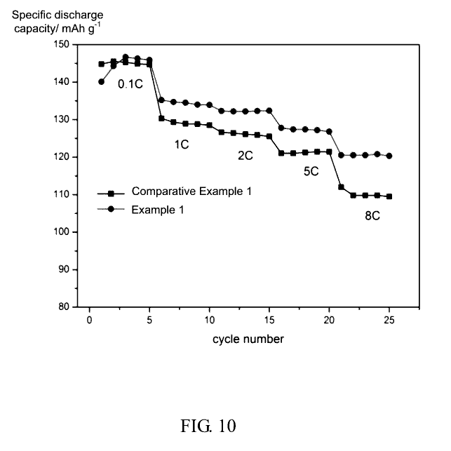

Referring to FIG. 8 and FIG. 9, which show discharging curves of the battery using the conventional polyolefin separator and the battery using the composite separator of Example 1, and the curves respectively are the third cycles in each current rate. The discharge capacities of the battery using the conventional polyolefin separator at 0.1 C, 1 C, 2 C, 5 C, and 8 C are 145.3, 129.2, 126.1, 121.4, and 109.8 mAh/g, respectively. The discharge capacities of the battery using the composite separator of Example 1 at the same current rates are 146.7, 134.7, 132.3, 127.4, and 120.5 mAh/g, respectively, which are all higher than the corresponding discharge capacities of the battery using the conventional polyolefin separator. Referring to FIG. 10, with the discharge current rate increases, the battery using the composite separator of Example 1 shows better capacity retention, which reveals that the composite separator has an excellent current rate performance.

In the present method, the inorganic nano sol is modified first to have a C═C group. The C═C group forms a homogeneous copolymer with both acrylic acid and methyl methacrylate, so that a uniform dispersion of the inorganic nano sol in the P(AA-MMA) can be realized. The dispersion is then crystallized at certain temperature and pressure. By controlling the crystallization process, the formed oxide nanoparticles avoided aggregating together to obtain the composite having the oxide nanoparticles uniformly dispersed in the P(AA-MMA). Finally this composite and lithium hydroxide are reacted in the organic solvent, and the energy generated by the reaction disperses the oxide nanoparticles evenly to obtain the transparent and clear liquid dispersion. The liquid dispersion can be easily composited with the porous film, and is especially suitable for the electrospinning film having the large porosity.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a composite separator, the method comprising:
preparing a liquid dispersion of single ion nanoconductors;
mixing the liquid dispersion of the single ion nanoconductors uniformly with a polymer to form a film casting solution; and
applying the film casting solution to a surface of a porous film.

2. The method of claim 1, wherein the preparing the liquid dispersion of single ion nanoconductors comprises:
forming a solution of nano sol through a hydrolysis reaction;
adding a silane coupling agent containing a C═C group in the solution of nano sol, and heating in a protective gas to have a reaction thereby obtaining a solution of C═C group grafted nano sol;
adding a methyl methacrylate monomer, an acrylic acid monomer, and an initiator to the solution of C═C group grafted nano sol, and heating to have a reaction thereby forming a nano sol-P(AA-MMA) composite;
heating the nano sol-P(AA-MMA) composite at a pressure of about 1 MPa to about 2 MPa in a liquid phase medium at a temperature of about 145° C. to about 200° C. to obtain a dehydroxy crystalline oxide nanoparticle-P(AA-MMA) composite; and
mixing and heating the dehydroxy crystalline oxide nanoparticle-P(AA-MMA) composite and lithium hydroxide in an organic solvent to obtain the liquid dispersion of single ion nanoconductors.

3. The method of claim 2, wherein the nano sol is selected from the group consisting of titanium sol, aluminum sol, silicon sol, zirconium sol, and combinations thereof.

4. The method of claim 2, wherein the oxide nanoparticle is selected from the group consisting of titanium oxide, aluminum oxide, silicon oxide, zirconium oxide, and combinations thereof.

5. The method of claim 2, wherein the forming the solution of nano sol comprises:
dissolving at least one of a titanium compound, an aluminum compound, a silicon compound, and a zirconium compound capable of having a hydrolysis reaction in an organic solvent to form a first solution;
forming a second solution by mixing water and another organic solvent;
mixing the first solution with the second solution to form a mixture; and
heating the mixture to form the solution of nano sol.

6. The method of claim 5, further comprising adjusting a pH value of the second solution or the mixture to 3 to 4 or 9 to 10 by adding an acid or alkali.

7. The method of claim 5, wherein the at least one of the titanium compound, the aluminum compound, the silicon compound, and the zirconium compound is selected from the group consisting of organic ester compounds, organic alcohol compounds, oxysalts, halides, and combinations thereof.

8. The method of claim 5, wherein the at least one of the titanium compound, the aluminum compound, the silicon compound, and the zirconium compound is selected from the group consisting of tetraethyl orthosilicate, tetramethyl orthosilicate, triethoxysilane, trimethoxysilane, trimethoxy(methyl)silane, methyltriethoxysilane, aluminium isopropoxide, aluminium tri-sec-butoxide, titanium sulfate, titanium tetrachloride, tetrabutyl titanate, titanium(IV) ethoxide, titanium tetraisopropanolate, titanium(IV) tert-butoxide, diethyl titanate, zirconium(IV) butoxide, zirconium tetrachloride, zirconium(IV) tert-butoxide, zirconium n-propoxide, and combinations thereof.

9. The method of claim 5, wherein a molar ratio of the water in the second solution to titanium, aluminum, silicon, and zirconium in the first solution is about 3:1 to about 4:1.

10. The method of claim 5, wherein the mixture is heated at about 55° C. to about 75° C.

11. The method of claim 2, wherein the silane coupling agent is selected from the group consisting of diethylmethylvinylsilane, vinyltris(tert-butylperoxy)silane, ethoxydimethylvinylsilane, vinyltri-t-butoxysilane, vinyltriisopropenoxysilane, diethoxy(methyl)vinylsilane, triethoxyvinylsilane, vinyltrimethoxysilane, dimethoxymethylvinylsilane, diethoxymethylvinylsilane, vinyltriacetoxysilane, tri(isopropoxy)vinylsilane, trimethoxy(7-octen-1-yl)silane, vinylmethyldimethoxysilane, and combinations thereof.

12. The method of claim 2, wherein a molar ratio of the nano sol to the silane coupling agent is about 1:100 to about 1:20.

13. The method of claim 1, wherein a size of the single ion nanoconductors is less than 10 nanometers.

14. The method of claim 2, wherein the dehydroxy crystalline oxide nanoparticle-P(AA-MMA) composite and lithium hydroxide is heated at about 60° C. to about 90° C.

15. The method of claim 1, wherein a mass ratio of the single ion nanoconductors to the polymer is about 1:20 to about 1:1.

16. The method of claim 1, wherein the porous film is selected from the group consisting of polyolefin porous film, nonwoven fabric porous film, electrospinning film, and combinations thereof.

17. The method of claim 16, wherein the nonwoven fabric is selected from the group consisting of polyimide nanofiber nonwoven fabric, polyethylene terephthalate nanofiber nonwoven fabric, cellulose nanofiber nonwoven fabric, aramid nanofiber nonwoven fabric, glass fiber nonwoven fabric, nylon nanofiber nonwoven fabric, polyvinylidene fluoride nanofiber nonwoven fabric, and combinations thereof.

18. The method of claim 16, wherein the electrospinning film is selected from the group consisting of polyimide electrospinning film, polyethylene terephthalate electrospinning film, polyvinylidene fluoride electrospinning film, and combinations thereof.

19. The method of claim 1, wherein the polymer is selected from the group consisting of poly(methyl methacrylate), poly(vinylidene fluoride-hexafluoropropylene), polyacrylonitrile, and polyethylene oxide, and combinations thereof.

20. The method of claim 1, wherein the liquid dispersion of single ion nanoconductors is transparent and clear.
